(19) United States
(12) Patent Application Publication
(10) Pub. No.: US 2004/0089525 A1
(43) Pub. Date: May 13, 2004

(54) Wire and wireless power switch control device

(76) Inventor: Chao Chuan Chien, Hsin-Chuang City (TW)

Correspondence Address: Quintero Law Office, 3rd Floor, 1617 Broadway, Santa Monica, CA, 90404, US

(21) Appl. No.: 10/460,445

(22) Filed: Jun. 12, 2003

Related U.S. Application Data
(63) Continuation-in-part of application No. 10/292,691, filed on Nov. 12, 2002.

(51) Int. Cl. H01H 35/02

(52) U.S. Cl. 200/61.52

(57) ABSTRACT

A wireless power switch control device, comprising: a detection and transmission circuit for detecting an obliquity of an object, upon the obliquity of said object reaching to a specified level, said detection and transmission circuit will transmit a wireless signal; and a receiving and control circuit upon receiving the wireless signal from said detection and transmission circuit will turn off a power of a outlet so as to prevent sparking of an electric wire. The invention also provides a wire power switch control device if the environment requires.

### RELATED PATENT APPLICATIONS

This application is a C-I-P application related to pending U.S. patent application Ser. No. 10/292,691, filed date Nov. 12, 2002, which is hereby incorporated by reference. The characteristic of the U.S. patent application Ser. No. 10/292,691 is continue using in the present invention.

### FIELD OF THE INVENTION

The present invention relates generally to a power switch. More particularly, the present invention relates to a wire and wireless power switch control device.

### BACKGROUND OF THE INVENTION

Generally speaking, a Christmas tree in accordance with the prior art has a plurality of lamps. These lamps are connected to a power outlet via an electric wire. Upon the Christmas tree tipping and providing power continually, may be arisen a sparking of an electric wire and then caused a fire accident. In addition, a wire-control Christmas tree is provided in the market, which controlled the power ON/OFF by way of a wire and a switch. However, if the Christmas tree tipping and not turning off the power timely by the switch, may be arisen a sparking of an electric wire and then caused a fire accident yet.

As a result, an improved wireless power switch control device that reduces damage by the sparking of an electric wire is needed.

### SUMMARY OF THE INVENTION

It is an advantage of the present invention to provide a wire and wireless power switch control device for protecting the outlet and providing security of power.

In accordance with one embodiment of the invention, an wireless power switch control device is provided comprising: a detection and transmission circuit for detecting an obliquity of an object, upon the obliquity of the object reaching to a specified level, the detection and transmission circuit transmits a wireless signal; and a receiving and control circuit upon receiving the wireless signal from the detection and transmission circuit turns off a power of a outlet so as to prevent sparking of an electric wire.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an assembly view of a wireless power switch control device in accordance with one embodiment of the present invention.

FIG. 2 is a block diagram of a detection and transmission circuit in accordance with one embodiment of the present invention.

FIG. 3 is a block diagram of a receiving and control circuit in accordance with one embodiment of the present invention.

FIG. 4 is a block diagram of a wire power switch control device in accordance with one embodiment of the present invention.

### DESCRIPTION OF THE PREFERRED EMBODIMENTS

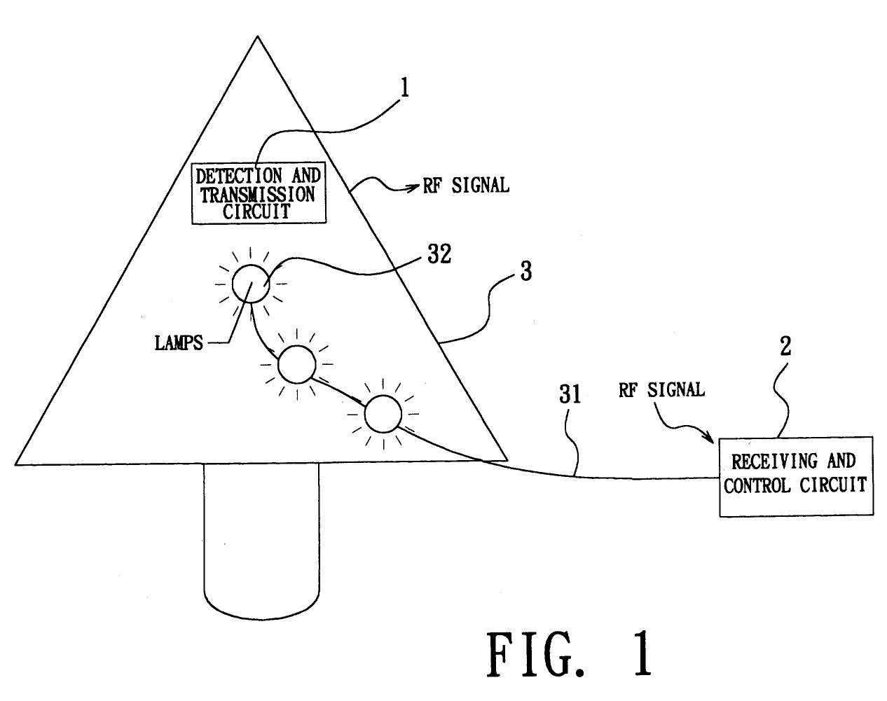

Referring first to FIG. 1, there is an assembly view of a wireless power switch control device in accordance with one embodiment of the present invention. The wireless power switch control device comprises: a detection and transmission circuit 1; and receiving and control circuit 2.

Wherein, the detection and transmission circuit 1 is positioned on an object 3 such as a Christmas tree, a building, or the like for detecting an obliquity of the object 3. A plurality of lamps 32 also positioned on the object 3 for providing light in various color and patterns. The lamps 32 are connected each other in sequence by a wire and then connected to the receiving and control circuit 2 via an electric wire 31. Upon the obliquity of the object 3 reaching to a specified level (for example 30 degree, or the like), the detection and transmission circuit 1 transmits a wireless signal to the receiving and control circuit 2, upon receiving the wireless signal the receiving and control circuit turns off a power of a outlet (shown in FIG. 3) so as to prevent sparking of an electric wire 31.

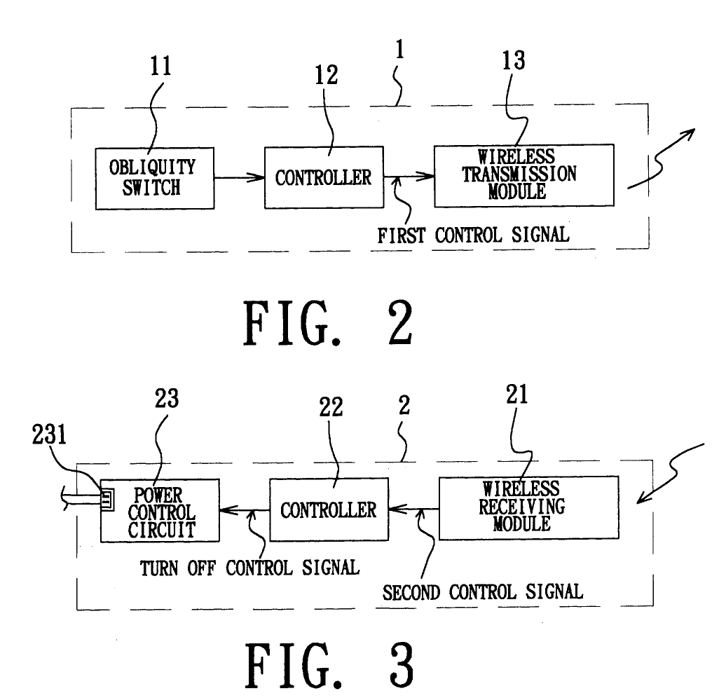

Referring to FIG. 2 is a block diagram of a detection and transmission circuit in accordance with one embodiment of the present invention. The detection and transmission circuit 1 further comprising: an oblique switch 11; a controller 12; and a wireless transmission module 13.

Wherein, the oblique switch 11 is placed in the object 3 for detecting the obliquity of the object 3. According to one embodiment of the present invention, the oblique switch 11 further comprising two conductive plates (not shown) and a metal ball (not shown), upon the obliquity of the object 3 reaching to a specified level (for example 30 degree, or the like), the metal ball leaved form one of the conductive plates so as to make the oblique switch 11 becoming a open circuit state. Wherein, the controller 12 coupled to the oblique switch 11, upon the obliquity of the object 3 reaching to a specified level generates a first control signal; and the wireless transmission module 13 coupled to the controller 12, upon receiving the first control signal from the controller 12 transmits the wireless signal, wherein the wireless signal is for example but not limit to a radio frequency (RF) signal or a infrared (IR) signal and the wireless transmission module 13 is for example but not limit to a radio frequency (RF) module or a infrared (IR) module.

Referring to FIG. 3 is a block diagram of a receiving and control circuit in accordance with one embodiment of the present invention. The receiving and control circuit 2 that is placed closely to the power source further comprises: a wireless receiving module 21; a controller 22; and a power control circuit 23.

Wherein, the wireless receiving module 21 upon receiving the wireless signal from the detection and transmission circuit 13 will recover the wireless signal into a second control signal; the controller 22 coupled to the wireless receiving module 21, upon receiving the second control signal will generate a turn off control signal, the wireless receiving module 21 is for example but not limit to a radio frequency (RF) module or a infrared (IR) module; and the power control circuit 23 coupled to the controller 22 comprising at least one outlet 231, upon receiving the turn off control signal will turn off the power of the outlet 231, therefore, the sparking of the electric wire 31 will not arise.

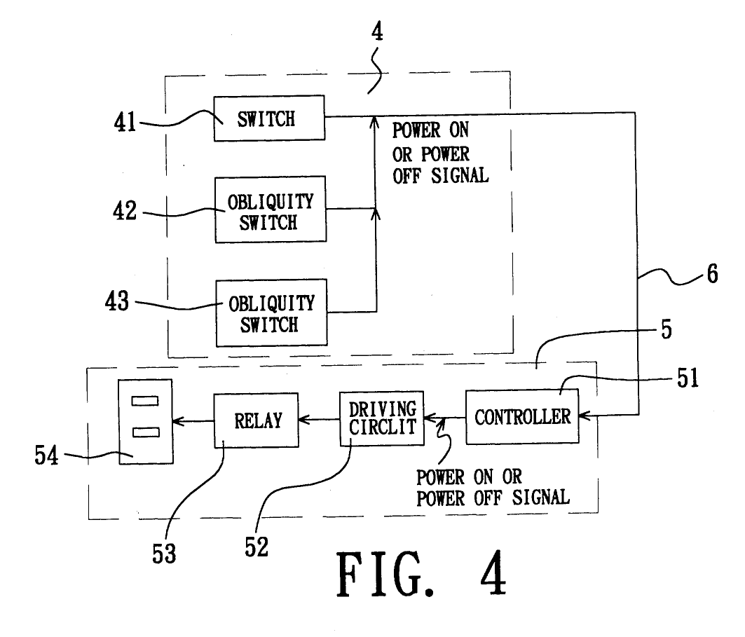

Actually, the present invention also provides a wire power switch control device if the environment requires. Referring to FIG. 4 is a block diagram of a wire power switch control device in accordance with one embodiment of the present invention. The wire power switch control device comprises: a detection circuit 4; and control circuit 5.

Wherein, the detection circuit 4 used for detecting an obliquity of an object such as a Christmas tree 3, upon the obliquity of the object 3 reaching to a specified level, the detection circuit 4 generates a power off signal; and a control circuit 5, coupled to the detection circuit 4 by an electric wire 6, upon receiving the power off signal from the detection circuit 4 turns off the power of the outlet 54 so as to prevent sparking of the electric wire 6.

Wherein, the detection circuit 4 further comprising: a switch 41, for enabling the detection circuit 4 is a TACT switch preferably; and at least one oblique switch 42, for detecting the obliquity of the object 3; while the switch 41 being turned on at initialization, the oblique switch 42 stays at conducting state and the detection circuit 4 sends the power on signal to the control circuit 5 to turn on the power of the outlet 54; upon the obliquity of the object 3 reaching to the specified level, the oblique switch 42 becoming an opening state and sending the power off signal to the control circuit 5 to turn off the power of the outlet 54 so as to prevent sparking of the electric wire.

Furthermore, the control circuit 5 further comprising: a controller 51, coupled to the detection circuit 4 for receiving the power on and power off signals and controlling the control circuit 5 according the power on and power off signals; a driving circuit 52, coupled to the controller 51 and controlled by the controller 51 according the power on and power off signals; a relay 53, coupled to the driving circuit 52 and controlled by the driving circuit 52 according the power on and power off signals; and a outlet 54, coupled to the relay 53 and controlled by the relay 53 according the power on and power off signals. Wherein the oblique switch is a roll ball switch and the driving circuit 52 is a transistor, such as npn or pnp type transistor, FET, etc.

The working principle of the present invention is as follows: while the switch 41 being turned on at initialization, the oblique switch 42 staying at a conducting state and the detection circuit 4 sending the power on signal to the controller 51; the controller 51 receives the power on signal and then sends an enable signal (for example a high level signal) to the driving circuit 52; the driving circuit 52 becomes an on state and generates a current to the relay 53 and then the relay 53 turns on the power of the outlet 54. Upon the obliquity of the object 3 reaching to the specified level, for example 30 degrees, or the like, the oblique switch 42 becomes an opening state and sends the power off signal to the controller 51; the controller 51 receives the power off signal and then sends an disable signal (for example a low level signal) to the driving circuit 52; the driving circuit 52 becomes an off state because without enough current to enable the relay 53 and then the relay 53 turns off the power of the outlet 54 so as to prevent sparking of the electric wire. Furthermore, while the obliquity of the object 3 reaching the specified level and the power of the outlet 54 being powered off, the switch 41 will become disabled so as to prevent the power of the outlet 54 being powered on under obliquity condition and caused sparking of the electric wire 6.

While the invention has been described with reference to a preferred embodiment thereof, it is to be understood that modifications or variations may be easily made without departing from the spirit of this invention, which is defined by the appended claims.

What is claimed is:

1. A wireless power switch control device, comprising:
a detection and transmission circuit for detecting an obliquity of an object, upon the obliquity of the object reaching to a specified level, said detection and transmission circuit transmits a wireless signal; and
a receiving and control circuit upon receiving the wireless signal from said detection and transmission circuit turns off a power of a outlet so as to prevent sparking of an electric wire.

2. A wireless power switch control device as claimed in claim 1, wherein the wireless signal is a radio frequency (RF) signal preferably.

3. A wireless power switch control device as claimed in claim 1, wherein the wireless signal is an infrared (IR) signal preferably.

4. A wireless power switch control device as claimed in claim 1, wherein said detection and transmission circuit further comprising:
an oblique switch for detecting the obliquity of said object;
a controller coupled to said oblique switch, upon the obliquity of said object reaching to a specified level generates a first control signal; and
a wireless transmission module coupled to said controller, upon receiving the first control signal from said controller transmits the wireless signal.

5. A wireless power switch control device as claimed in claim 4, wherein said oblique switch further comprising two conductive plates and a metal ball, upon the obliquity of said object reaching to a specified level, said metal ball is leaved form one of said conductive plates so as to make said oblique switch becoming a open circuit state.

6. A wireless power switch control device as claimed in claim 1, wherein said receiving and control circuit further comprising:
a wireless receiving module, upon receiving the wireless signal from said detection and transmission circuit recovers the wireless signal into a second control signal;
a controller coupled to said wireless receiving module, upon receiving the second control signal generates a turn off control signal; and
a power control circuit coupled to said controller comprising at least one outlet, upon receiving the turn off control signal turns off the power of said outlet.

7. A wireless power switch control device as claimed in claim 1, wherein said object is a building preferably.

8. A wireless power switch control device as claimed in claim 1, wherein said object is a Christmas tree preferably.

9. A power switch control device, comprising:
a detection circuit for detecting an obliquity of an object, upon the obliquity of an object reaching to a specified level, said detection circuit transmits a power off signal; and
a control circuit, coupled to said detection circuit by an electric wire, upon receiving the power off signal from said detection circuit turns off the power of a outlet so as to prevent sparking of said electric wire.

10. A power switch control device as claimed in claim 9, wherein said detection circuit further comprising:
a switch, for enabling said detection circuit; and
at least one oblique switch, for detecting the obliquity of said object;
while said switch being turned on at initialization, said oblique switch stays at conducting state and said detection circuit sends a power on signal to said control circuit to turn on the power of said outlet; upon the obliquity of said object reaching to a specified level, said oblique switch becoming opening state and sending said power off signal to said control circuit to turn off the power of said outlet so as to prevent sparking of said electric wire.

11. A power switch control device as claimed in claim 9, wherein said control circuit further comprising:
a controller, coupled to said detection circuit for receiving said power on and power off signals and controlling said control circuit according said power on and power off signals;
a driving circuit, coupled to said controller and controlled by said controller according said power on and power off signals;
a relay, coupled to said driving circuit and controlled by said driving circuit according said power on and power off signals; and
a outlet, coupled to said relay and controlled by said relay according said power on and power off signals.

12. A power switch control device as claimed in claim 10, wherein said oblique switch is a roll ball switch.

13. A power switch control device as claimed in claim 11, wherein said driving circuit is a transistor or FET.
